(19) United States
(12) Patent Application Publication
(10) Pub. No.: US 2009/0309547 A1
(43) Pub. Date: Dec. 17, 2009

(54) CHARGING METHOD, BATTERY PACK AND CHARGER FOR BATTERY PACK

(76) Inventor: Toshiyuki Nakatsuji, Hyogo (JP)

Correspondence Address: MCDERMOTT WILL & EMERY LLP, 600 13TH STREET, NW, WASHINGTON, DC, 20005-3096, US

(21) Appl. No.: 12/297,128

(22) PCT Filed: Apr. 5, 2007
(86) PCT No.: PCT/JP2007/057655

§ 371 Date: Oct. 14, 2008

(30) Foreign Application Priority Data
Apr. 14, 2006 (JP) 2006-112147

(51) Int. Cl. H02J 7/00; H02J 7/04; H02J 7/06

(52) U.S. Cl. 320/134; 320/162; 320/164

(57) ABSTRACT

A charging method includes a constant-current charging step wherein a constant charge current is supplied to a secondary battery to be charged to a predetermined end voltage; and a constant-voltage charging step wherein the predetermined end voltage is maintained by reducing the charge current after said secondary battery is charged to the end voltage, wherein: said constant-current charging step includes the charging step to be carried out with the end voltage set to OCV which is a voltage when no current is flowing, and with a voltage of a charge terminal of said battery pack set to an overvoltage above said OCV, and said constant-voltage charging step includes the step of reducing the voltage across the charge terminals to the after the voltage across the charge terminals is increased to the overvoltage or after the charge current of the charge terminal is reduced to or below a predetermined current level.

### TECHNICAL FIELD

The present invention relates to a charging method, a battery pack and a charger for the battery pack, and more particularly relates to a technique for reducing a charging time.

### BACKGROUND ART

FIG. 7 is a graph showing a typical conventional method for controlling a charge voltage and a charge current, which realizes a shorter charging time. FIG. 7 shows the case of a lithium ion battery, wherein α1 indicates changes in charge voltage of a secondary battery and α2 indicates changes in charge current to be supplied to the secondary battery.

Firstly, changes in charge voltage are explained. A trickle charging area, wherein a small constant current I1, e.g. a charge current of 50 mA is supplied, starts from the beginning of the charging and ends when a cell voltage of one cell, or cell voltages of all the plurality of cells have reached the same end voltage Vm for the trickle charging e.g. 2.5 V.

When the cell voltage reaches the end voltage Vm, a transition is made from the trickle charging area to a constant current (CC) charging area, wherein the end voltage Vf is being applied across the charge terminals of a battery pack until the terminal voltage across the charge terminals reaches a predetermined end voltage Vf (4.2 V per cell i.e., 12.6 V in the case of three cells connected in series). In this constant current (CC) charging area, applied is a charge current, which is obtained by multiplying 70% of 1 C by the number P of the cells connected in parallel, provided that a current value with which a nominal capacity NC is discharged in an hour by carrying out the constant-current discharging is 1 C.

When the terminal voltage across the charge terminals reaches the end voltage Vf, a transition is made from the constant-current charging area to a constant-voltage (CV) charging area wherein a charge current is supplied while reducing a charge current value so as not to exceed the end voltage Vf until the charge current value is decreased to a current value I3 as set based on temperatures. In this state, it is determined that the charge current has been supplied to the full charge, and the supply of the charge current is stopped. With this structure, the shorter charging time can be realized by increasing the current to be supplied to the constant current (CC) charging area. An amount of electric charges injected within the same period of time can be increased not only by increasing the charge current, but also by increasing the charge voltage. For example, according to Patent Document 1, the residual capacity is detected before carrying out the constant-current charging with an overvoltage, and the charging is carried out only with respect to those with small residual capacities, thereby preventing overcharging.

However, the conventional technology disclosed in Patent Document 1 has such problem that the residual capacity needs to be measured before carrying out the charging. Besides, an overvoltage is liable to be applied to the secondary battery although influences are not significant.

### Patent Document 1:

Japanese Unexamined Patent Publication No. Tokukaihei 6-78471/1994

### DISCLOSURE OF THE INVENTION

It is therefore an object of the present invention to provide a charging method, a battery pack and a charger for the battery pack, which permits the time required for charging to be reduced without applying an overvoltage to a secondary battery.

A charging method according to one aspect of the present invention includes: a constant-current charging step wherein a constant charge current is supplied to a secondary battery to be charged to a predetermined end voltage; and a constant-voltage charging step wherein the predetermined end voltage is maintained by reducing the charge current after the secondary battery is charged to the end voltage, wherein the constant-current charging step includes a charging step to be carried out with the end voltage set to an open circuit voltage (OCV) which is a voltage when no current is flowing, and with a voltage across charge terminals of the battery pack set to an overvoltage above the OCV, and the constant-voltage charging step includes a step of reducing the voltage across the charge terminals to the OCV after the voltage across the charge terminals is increased to the overvoltage or after the charge current across the charge terminals is reduced to or below a predetermined current level.

According to the foregoing method for charging the secondary battery such as a lithium ion battery, the constant-current (CC) charging is performed wherein a constant charge current is supplied to the secondary battery to be charged to a predetermined end voltage (e.g. 4.2 V in the case of the lithium ion battery) as a target voltage, subsequent to the trickle charging to be carried out with a small current in the initial stage of the charging process. Then, after the secondary battery is charged to the end voltage, a constant-voltage charging is performed wherein the predetermined end voltage is maintained by reducing the charge current. In the constant-voltage charging step, the end voltage is set to an open circuit voltage (OCV) which is a voltage when no current is flowing, and in the constant-current charging step, the voltage across the charge terminals of the battery pack is set to an overvoltage above the OCV. After the voltage across the charge terminals reaches the overvoltage and a transition is made to the constant-voltage charging, or after the charge current of the charge terminal is reduced to or below a predetermined current level, the voltage across the charge terminals is reduced to the end voltage.

As described, according to the foregoing charging method of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

### BRIEF DESCRIPTION OF THE DRAWINGS

FIG. 1 is a block diagram showing the electrical structure of a charging system employing a charging method according to a first embodiment of the invention,

FIG. 2 is a graph showing a method for controlling a charge voltage and a charge current by the charging method according to the first embodiment of the invention,

FIG. 3 is a block diagram showing another example of a trickle charge circuit,

FIG. 4 is a block diagram showing still another example of the trickle charge circuit,

FIG. 5 is a graph showing another method for controlling a charge voltage and a charge current by the charging method according to the first embodiment of the invention,

FIG. 6 is a block diagram showing the electrical structure of a charging system employing a charging method according to a second embodiment of the invention, and

FIG. 7 is a graph showing another method for controlling a charge voltage and a charge current according to a typical conventional technology.

### BEST MODE FOR CARRYING OUT THE INVENTION

Hereinafter, embodiments of the present invention are described with reference to the accompanying drawings. In the following description, elements having the same structures/functions are designated by the same or similar reference numerals and are not repeatedly described in some cases.

### First Embodiment

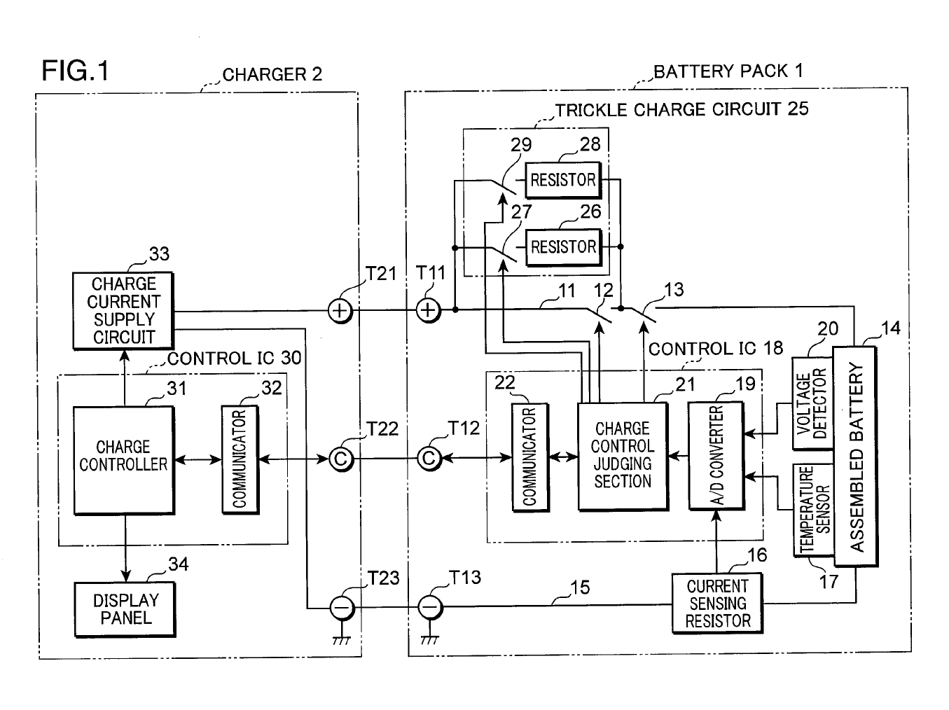

FIG. 1 is a block diagram showing the electrical structure of a charging system employing a charging method according to a first embodiment of the present invention. As shown in FIG. 1, the charging system includes a battery pack 1 and a charger 2 for charging the battery pack 1. The charging system of the present invention is not limited to the foregoing structure, and may further include a load equipment (not shown), to which power is supplied from the battery pack 1. In the case of the charging system of FIG. 1, the battery pack 1 is charged by the charger 2; however, in the case of the above example of the charging system provided with the load equipment, the battery pack 1 may be mounted on the load equipment to be charged via the load equipment. The battery pack 1 and the charger 2 are interconnected by high voltage direct current terminals T11, T21 for power supply, terminals T12, T22 for communication signals, and GND terminals T13, T23 for power supply and communication signals. For the charging system provided with the load equipment, terminals are provided in the same manner as the case of FIG. 1.

In the battery pack 1, FETs 12, 13 having different conduction modes for charging/discharging are provided in a high voltage direct current charge path 11 extending from the terminal T11, and the charge path 11 is connected to a high voltage terminal of an assembled battery 14. A low voltage terminal of the assembled battery 14 is connected to the GND terminal T13 via a low voltage direct current charge path 15, and a current sensing resistor 16 as a current detector for converting a charge current and a discharge current into current values is provided in this charge path 15.

The assembled battery 14 includes a plurality of secondary battery cells connected in series and the temperatures of the cells are detected by a temperature sensor 17 and are inputted to an analog/digital converter 19 in a control IC 18. A voltage across terminals of each cell is detected by a voltage detection circuit 20 and is inputted to the analog/digital converter 19 in the control IC 18. The current values detected by the current sensing resistor 16 are also inputted to the analog/digital converter 19 in the control IC 18. The analog/digital converter 19 converts the respective input values into digital values to be outputted to a charge control judging section 21.

The charge control judging section 21 includes a microcomputer and its peripheral circuits, calculates a voltage value, a current value and a pulse width (duty) of a charge current required to be outputted from the charger 2 in response to the respective input values from the analog/digital converter 19 and transmits them to the charger 2 via the terminals T12, T22; T13, T23 from a communicator 22. The charge control judging section 21 also performs a protection operation of, for example, cutting the FETs 12, 13 off if abnormality outside the battery pack 1 such as a short circuit between the terminals T11 and T13 or an abnormal current from the charger 2 or an abnormal temperature increase of the assembled battery 14 is detected based on inputs from the analog/digital converter 19.

The charge control judging section 21 constitutes a charge controller together with the FETs 12, 13, and switches ON the FETs 12, 13 to enable charging/discharging when a charging/discharging is being performed properly while switching them OFF to disable charging/discharging when an abnormality is detected.

In the charger 2, a request from the charge control judging section 21 is received by a communicator 32 of a control IC 30, and a charge controller 31 controls a charge current supply circuit 33 to supply a charge current of the above voltage value, a current value and a pulse width as requested. The charge current supply circuit 33 includes an AC-DC converter and a DC-DC converter, and converts an input voltage into a voltage value, current value and a pulse width as instructed by the charge controller 31, to be supplied to the charge paths 11, 15 via the terminals T21, T11; T23, T13. The charge controller 31 and the charge current supply circuit 33 constitute the charge controller of the present embodiment. Residual capacity data obtained through communication from the battery pack 1 is displayed on a display panel 34.

In the battery pack 1, a trickle charge circuit 25 is provided in parallel with the FET 12 for normal (quick) charge in the high voltage direct-current charge path 11. This trickle charge circuit 25 includes a series circuit made up of a current-limiting resistor 26 and a FET 27. The charge control judging section 21 performs a trickle charging in an initial state of the charging process and in the last stage close to the full charge by switching OFF the FET 12 for the quick-charging and switching ON the FET 27 for quick-charging while keeping the FET 13 for discharging in the ON state. The charge control judging section 21 performs a trickle charging in the normal charging/discharging by switching ON the FET 12 for the quick-charging and switching OFF the FET 27 for quick-charging while keeping FET 13 for discharging in the ON state.

The present embodiment has the following essential feature. That is, the trickle charge circuit 25 has another series circuit which is made up of a current-limiting resistor 28 and a FET 29, and which is connected in parallel to the series circuit of the current-limiting resistor 26 and the FET 27. The charge control judging section 21 divides a trickle charging area into a first half and a second half. In the first half, the charge control judging section 21 carries out a trickle charging in the same manner as the conventional trickle charging method using the current-limiting resistor 26, wherein the FET 27 is switched ON and the FET 29 is switched OFF. In the second half, the charge control judging section 21 carries out a trickle charging with a supply current larger than the conventional trickle charge current using the current-limiting resistor 28 having a smaller resistance value than the current-limiting resistor 26 wherein the FET 29 is switched ON and the FET 27 is switched OFF. Another essential feature of the present embodiment lies in the following. That is, the charge control judging section 21, which performs the constant-current and constant-voltage charging, carries out the constant-current charging with the end voltage set to the OCV, and carries out the constant-voltage charging with the voltage across the charge terminals T11 and T13 set to an overvoltage above the end voltage, wherein when a transition is made from the constant-current charging to the constant-voltage charging, and the charge current is reduced to or below a predetermined current level, the voltage across the charge terminals T11 and T13 is reduced to the end voltage.

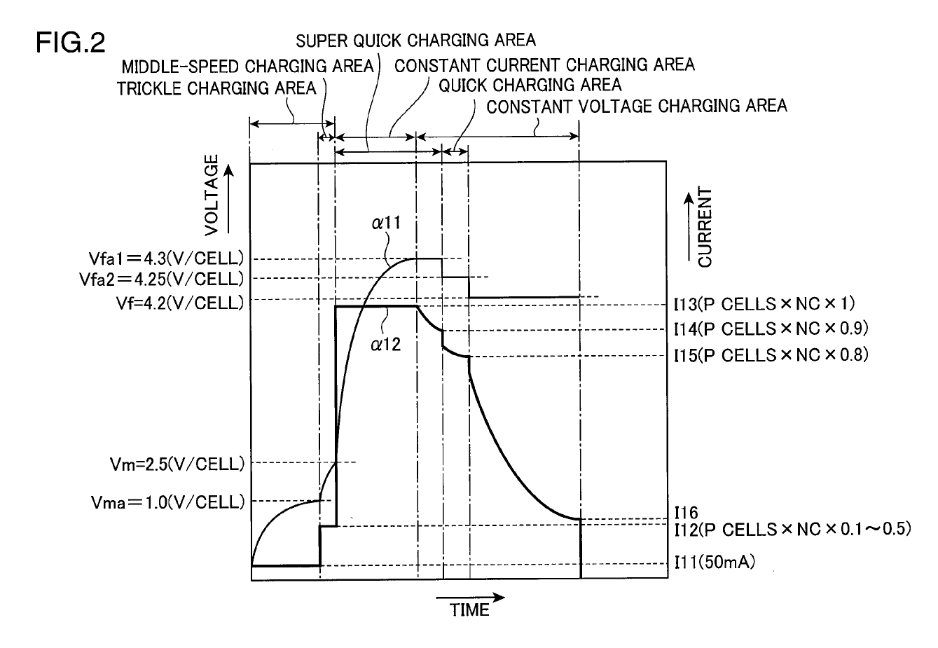

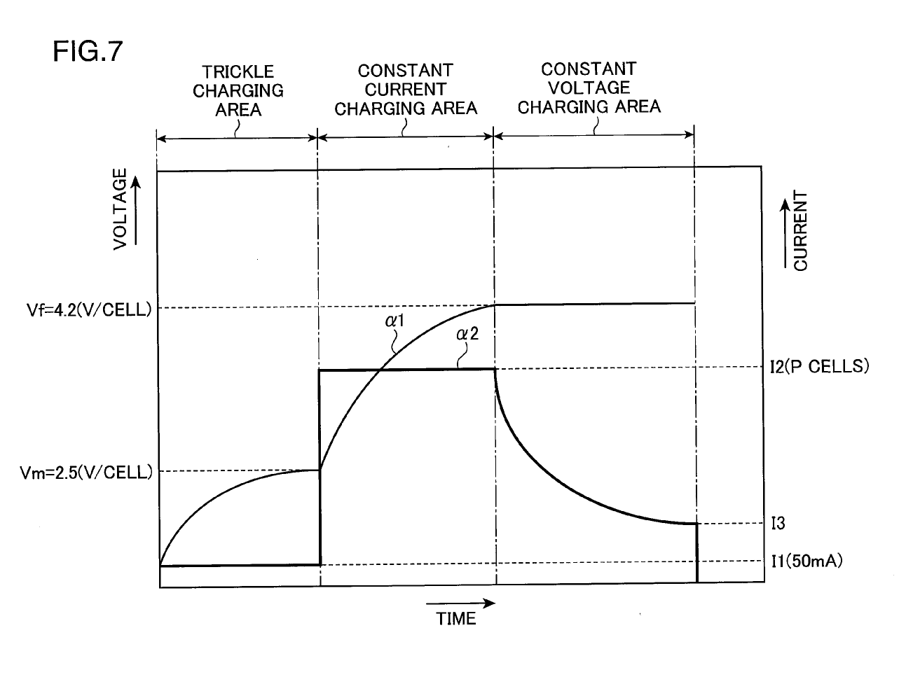

FIG. 2 is a graph showing a method of controlling the charge voltage and charge current according to the above described present embodiment. FIG. 2 also shows the case of a lithium ion battery similar to FIG. 7 showing the conventional technology described above, wherein α11 indicates changes in voltage relating to each cell of the battery pack 1 and the assembled battery 14, and α12 indicates changes in charge current to be supplied to the secondary battery 1.

Firstly, changes in voltage are explained. A trickle charging area starts from the beginning of the charging as in the case of conventional method. The charge control judging section 21 first requests the charge control section 31 via the communicators 22 and 32 for a trickle charge current, and switches ON the FET 13 for discharging and switches OFF the FET 12 for charging, and in the meantime, switches ON the FET 27 and switches OFF the FET 29. The charge control judging section 21 then starts carrying out the trickle charging using the current-limiting resistance 26 with a small constant current I11, e.g. a charge current of 50 mA as a trickle charge current as in the conventional method. The trickle charging is continued until the voltage detection circuit 20 detects that a cell voltage of a cell or cell voltages of all the plurality of cells reach a switch voltage Vma newly set in this embodiment, e.g. 1.0 V.

When the respective cell voltages of all the plurality of cells have reached the switch voltage Vma, a middle-speed current charging area in the trickle charging area starts where the charge control judging section 21 performs the charging with a larger current I12 than the conventional trickle charge current using the current-limiting resistor 28 having a smaller resistance value than the current-limiting resistor 26 as described earlier by switching ON the FET 29 and switching OFF the FET 27. In this middle-speed current charging area, a charge current I12 is applied, which is obtained by multiplying 5 to 20% of an 1 C by the number P of the cells connected in parallel, provided that a current value with which a nominal capacity NC is discharged in an hour by carrying out the constant current discharging is a level 1 C (e.g. 200 mA at 5% when NC=2000 mAh and two cells are connected in parallel). Thereafter, the trickle-charging process continues until the voltage detection circuit 20 detects that a cell voltage of one cell, or cell voltages of all the plurality of cells have reached the same end voltage Vm as that of the conventional trickle charging method, e.g. 2.5 V.

Specifically, the trickle charging in the present embodiment is performed in the following manner. That is, the trickle charging process is performed by dividing into two areas, i.e., the first half trickle charging area wherein a conventional trickle charging is performed with a current value I11 adopted in the conventional trickle charging method, and the second half trickle charging area wherein a trickle charging is performed with a current value I12 larger than the current value I11, wherein the trickle charging by the conventional current value I11 is performed in a shorter period of time than the conventional current value I11, and in the second half of the trickle charging period (area) which is defined as the middle speed current charging area, the charging is performed with a larger current value I12 than the current value I11.

The current values I11, I12 of the trickle charging are determined based on a difference between the voltage applied across the terminals T11, T13 and the voltage across the terminals of the assembled battery 14, the resistance values of the current-limiting resistors 26, 28, the FETs 27, 29 and the like. For such charge current supply circuit 33 of the charger 2 capable of supplying a current value I12 which is larger than the current value I11 adopted in the conventional trickle charging, the same current may be requested in the trickle charging area and the middle-speed charging area. However, it is possible to reduce losses caused by the current-limiting resistor 26 and the like in the trickle charging by requesting different current values respectively for the trickle charging area and the middle-speed charging area.

When the cell voltages reach the end voltage Vm, a transition is made to a super quick charging area wherein the charging is performed with a constant current (CC), and the charge control judging section 21 requests the charge controller 31 via the communicators 22, 32, for a large charge current I13, e.g. 1 C and an overvoltage Vfa1 newly set in this embodiment, e.g. 4.3 V per cell and in the meantime switching ON the FET13 for discharging and ON the FET12 for charging, and switching OFF the FETs 27 and 29 of the trickle charge circuit 25, thereby starting the super quick charging period (area).

Thereafter, when the voltage across the terminals T11 and T13 is increased, and the current sensing resistor 16 detects a decrease in charge current to or below a predetermined current level I14, e.g. 0.9 C, which is smaller than the charge current I13, the charge control judging section 21 determines that a transition is made to the constant-voltage (CV) charging area, and requests the charge controller 31 via the communicators 22, 32, for a current equal to or above the current level I14 and an overvoltage Vfa2, e.g. 4.25 V per cell to continue the quick charge.

Even if the charge current is reduced in such a manner, the charge control judging section 21 requests the charge controller 31 via the communicators 22, 32a for a current equal to or above a current level I15 and the end voltage Vf, e.g. 4.2 V per cell as in the conventional constant-voltage (CV) charge when the voltage across the terminals T11 and T13 is raised again and the current sensing resistor 16 detects a reduction in charge current to or below the level I15, e.g. 0.8 C.

When the current sensing resistor 16 detects a reduction in current to or below a charge current I16, e.g. 0.1 C as in the conventional method with a charge voltage as a final full charge condition set to 4.2 V, the charge control judging section 21 judges the full charge and requests the charge controller 31 via the communicators 22, 32a for a charge current of 0 A and a charge voltage of 0V to stop the supply of the charge current.

The current value I13 can be set, for example, in a range of 1 C to 4 C; the current value I14, for example, in a range of 0.9 C to 1.5 C; the current value I15, for example, to 0.7 C; and the current value I16, for example, in a range of 0.15 C to 0.03 C. These current values may be suitably selected according to temperatures and the like. The overvoltage Vfa may be further segmented.

As described, according to the battery pack 1 and the charger 2 of the present embodiment, the trickle charge circuit 25 is capable of varying the charge current by providing another series circuit which is made up of the current limiting resistor 28 and the FET 29, and which is connected in parallel to the conventional series circuit of the current limiting resistor 26 and the FET 27. Then, the charge control judging section 21 controls the trickle charge circuit 25 to increase the charge current when the voltage detection circuit 20 detects that the cell voltage reaches the predetermined switch voltage Vma set lower than the end voltage Vm of the trickle charging. Furthermore, the current value quickly increases if the residual capacity of the secondary battery is not reduced significantly. If the cell voltages of the assembled battery 14 are lower than the switch voltage Vma and the residual capacity is almost null, the charging is performed at low speed with the conventional trickle charge current I11 to increase the cell voltages. Then, after the cell voltages are increased to the predetermined level, the charging is performed with the current I12 which is larger than the conventional trickle charge current. As a result, the time required for the trickle charging can be reduced, thereby reducing an overall time required for the charging.

Further, according to the battery pack 1 and the charger 2 in accordance with the present embodiment, the end voltage Vf is set to the OCV, and the charge control judging section 21 requests in the constant-current charging, the charge controller 31 via the communicators 22, 32 for such charge voltage that the voltage across the charge terminals T11 and T13 of the battery pack 1 becomes the overvoltages Vfa1, Vfa2 which is above the end voltage Vf for the constant-current (CC) charging. When the current sensing resistor 16 detects that the charge current I13 is reduced to or below the predetermined level I14, the charge control judging section 21 determines that a transition is made to the constant-voltage (CV) charging, and requests the charge controller 31 via the communicators 22, 32 for a charge voltage with which the voltage across the charge terminals T11 and T13 can be reduced to the end voltage Vf and for a charge current I15 with which the charge voltage as reduced can be maintained. With this structure, although the overvoltages Vfa1, Vfa2 above the end voltage Vf are applied across the charge terminals T11, T13 in the constant-current (CC) charging period, such voltages above the end voltage Vf are not applied to the respective cells. Moreover, a difference in voltage between the voltage Vfa1, Vfa2 and the cell voltage of the assembled cell 14 can be consumed by a voltage drop caused by the ON-resistance of the FETs 12, 13, the current sensing resistor 16, the wiring resistance of the charge paths 11, 15 and the like. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

Further, according to the battery pack 1 and the charger 2 in accordance with the present embodiment, voltages above the end voltage Vf are not applied to the respective cells in the constant current (CC) charging period, regardless of the state of the battery pack as described above. It is therefore possible to prevent overcharging. The charge current supply circuit 33 performs the super quick charging by setting the current value of the charge current I13 in a range of 1 C to 4 C which is higher than the charge current 0.7 C adopted in the conventional method. It is therefore possible to further reduce the charging time. Here, the lower limit for the current value in the super quick charging area is not particularly limited, as long as larger than the current value adopted in the conventional method, and any current 0.8 C or larger may be adopted in the present embodiment.

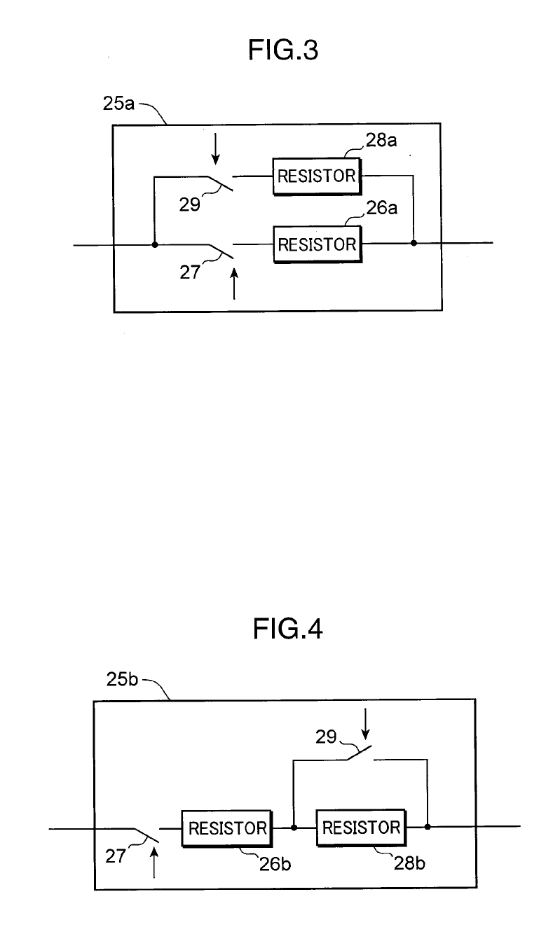

As one example structure of the present embodiment, the foregoing trickle charge circuit 25 includes the series circuit of the current limiting resistor 26 and FET 27 and the series circuit of the current limiting resistor 28 and FET 29, which are connected in parallel, the current limiting resistors 26 and 28 having mutually different resistance values, and the charge control judging section 21 switches ON the FET 27 corresponding to the current limiting resistor 26 having the higher resistance value in the initial stage of the charging, and switches ON the FET 29 corresponding to the current limiting resistor 28 having the lower resistance value when a cell voltage of a cell or cell voltages of all the plurality of cells reach a switch voltage Vma. The present embodiment is not limited to the foregoing structure, and for example, the trickle charge circuit 25a shown in FIG. 3, or the trickle charge circuit 25b shown in FIG. 4 or the like may be adopted.

In the trickle charge circuit 25, the use of the resistor 28 and the FET 29 may be stopped and a pulse control (PWM control) by ON/OFF controlling the FET 27 may be performed. In this case, the pulse control for the trickle charge circuit 25 is performed to obtain a trickle charge current having an average current value as requested.

As shown in FIG. 3, the trickle charge circuit 25a includes the series circuit of the current limiting resistor 26a and FET 27 and the series circuit of the current limiting resistor 28a and FET 29, which are connected in parallel, the current limiting resistors 26a and 28a having the same resistance values, and the charge control judging section 21 switches ON only either one of the FETs 27 and 29, for example the FET 27 corresponding to the current limiting resistor 26a so as to have a high resistance in the initial stage of the charging, and switches ON both of the FETs 27 and 29 corresponding to the current limiting resistors 26a and 28a so as to have a low resistance value when a cell voltage of a cell or cell voltages of all the plurality of cells reach the switch voltage Vma, thereby increasing the trickle charge current.

As shown in FIG. 4, the trickle charge circuit 25b includes two current limiting resistors 26b, 28b and one FET 27 which are connected in series, and another FET 29 is provided for bypassing the current limiting resistors 28b, and the charge control judging section 21 switches ON only the FET 27 so as to have a high resistance value in the initial stage of the charging, and switches ON only the FET 29 for bypassing the current limiting resistors 28b so as to have a low resistance value when a cell voltage of a cell or cell voltages of all the plurality of cells reach the switch voltage Vma, thereby increasing the trickle charge current. Other than the foregoing circuit structures, any circuit structures for the current limiting resistances and FETs may be adopted as long as a larger current I12 than the conventional trickle charge current I11 can be supplied.

According to the foregoing examples, it is determined on the side of the battery pack 1 that a transition has been made to the constant-voltage charging area based on a reduction in current to the current I14, and an overvoltage Vfa2 and current are requested to the charger 2. However, the present embodiment is not intended to be limited to the above structure, and it may be arranged to transit to the constant-voltage charging area based on a reduction in current on the side of the charger 2 in the similar manner, and to output the predetermined voltage and current.

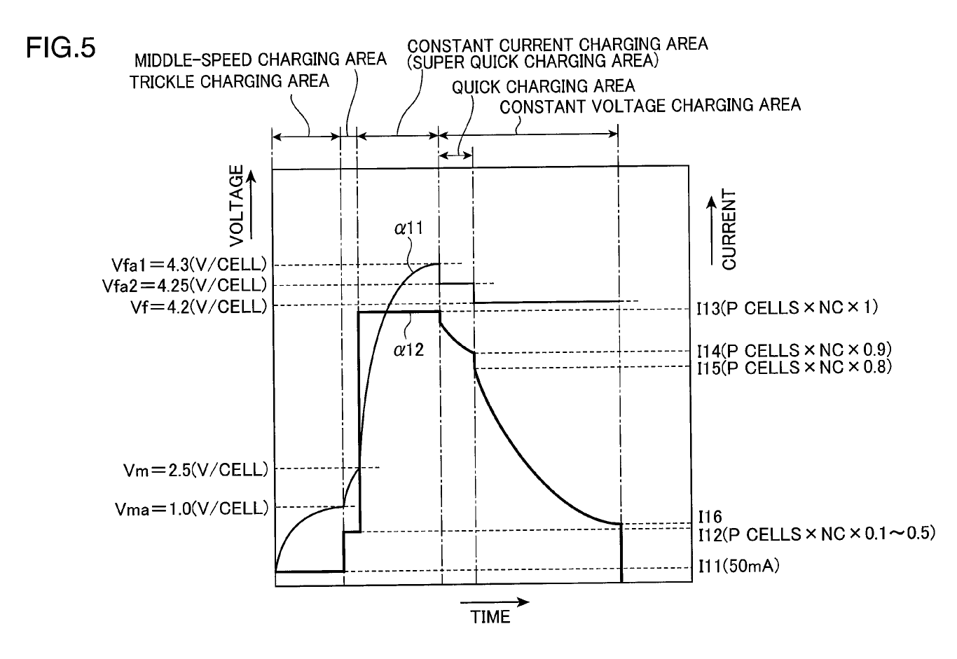

It may be also arranged on the side of the charger 2 such that a transition is made to the constant voltage (CV) charging when the voltage across the terminals T21 and T23 is increased to the overvoltage 1Vfa1, and to output the predetermined voltage and current. The method for controlling the charge voltage and current in this example is as shown in FIG. 5. When comparing FIG. 5 with FIG. 2, the charging time with the overvoltage Vfa1 is slightly longer in FIG. 2, and the residual capacity up to the full charge therefore decreases more in the case of FIG. 2 by the difference in charging time, thereby realizing a shorter charging time in the case of FIG. 2. However, when comparing FIG. 5 with the conventional method shown in FIG. 7, the method shown in FIG. 5 of the present embodiment wherein it is determined that a transition is made to the constant-voltage charging area based on the voltage across the terminals T21 and T23, and the voltage is reduced from the overvoltage Vfa1 to the overvoltage Vfa2, realizes a shorter constant-current charging period (area), thereby realizing a reduction in time required for an overall charging process as compared to the conventional method shown in FIG. 7.

In the case of constructing an electronic device system including a load device to have power supplied from the battery pack 1 in addition to the battery pack 1 and the charger 2 as described above, a current may be decreased due to the operation of the load device even during the charging. In this case, a judgment error can be prevented by making the judgment on the transition to the constant-voltage (CV) charging area at or above a predetermined voltage. Specifically, since the voltage across the terminals T21 and T23 decreases due to the operation of the load device, the judgment on the current drop may not be made when the voltage is decreased below the predetermined voltage.

### Second Embodiment

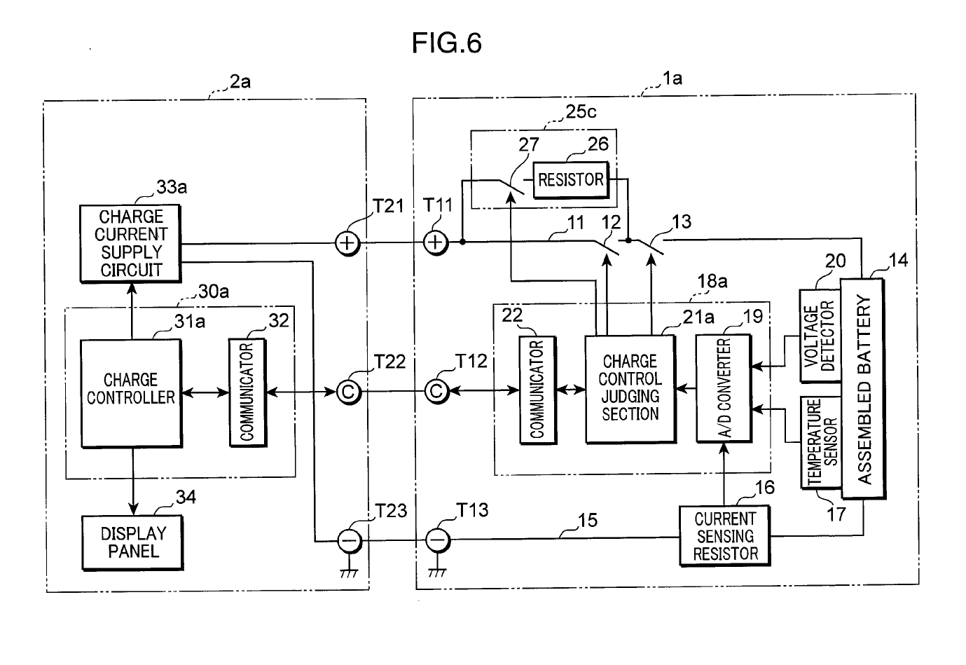

FIG. 6 is a block diagram showing the electrical structure of a charging system employing a charging method according to a second embodiment of the present invention. This charging system is similar to the one shown in FIG. 1 and corresponding parts are identified by the same reference numerals and not described. An essential feature of the charging system in accordance with the present embodiment lies in that only the conventional series circuit of the current limiting resistor 26 and FET 27 is provided in a trickle charge circuit 25c of a battery pack 1a and, instead, a charge current supply circuit 33a of a charger 2a can supply a current I12 in the middle-speed current charging area.

Thus, a charge control judging section 21a of a control IC 18a performs the trickle charging in a similar manner to the conventional method by switching ON the FETs 13, 27 and using the current limiting resistor 26 in the initial stage of the charging process as described above. The charge control judging section 21a then requests a charge controller 31a of a control IC 30a of the charger 2a via the communicators 22, 32, for a charge current of the current value I12 which is larger than the current value I11 in the trickle charging and is smaller than the constant current value I13 in the constant-current/constant-voltage charging when the cell voltage reaches a switch voltage Vma, and controls the trickle charge circuit 25c to switch OFF the FET 27 and switch ON the FET 12 for charging, so that the charge current from the charger 2a is directly outputted to the assembled battery 14. The charge controller 31a controls the charge current supply circuit 33a to supply a charge current of the current value I12 in response to the request. When the cell voltage reaches the end voltage Vm for the trickle charging, a transition is made to the super quick constant current/constant-voltage charging. The charge control judging section 21a then requests for a charge current of the constant current value I13, and the charge controller 31a controls the charge current supply circuit 33a to supply a charge current of the current value I13 in response to the request.

With the foregoing structure, the trickle charging time can be reduced, thereby reducing a time required for an overall charging process.

As described, according to the foregoing charging method of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

According to the charging method of the present invention, when the residual capacity of the secondary battery is not reduced significantly, a current value is increased immediately, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

Furthermore, according to the charging method of the present invention, it is possible to realize a shorter charging time in the trickle charging as describe above and at the same time to realize a shorter charging time in the constant current/constant-voltage charging, thereby realizing a further reduction in time required for an overall charging.

As described, according to the foregoing charging method of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

Accordingly to the battery pack of the present invention, when the residual capacity of the secondary battery is not reduced significantly, a current value is increased immediately; on the other hand, when the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

Accordingly to the battery pack of the present invention, when the residual capacity of the secondary battery is not reduced significantly, a current value is increased immediately; on the other hand, when the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

Furthermore, according to the charging method of the present invention, it is possible to realize a shorter charging time in the trickle charging as describe above and at the same time to realize a shorter charging time in the constant current/constant-voltage charging, thereby realizing a further reduction in time required for an overall charging.

As described, according to the foregoing charger of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting the charge voltage and the detected drop in current equal to the conventional levels, as a final full charge condition, it is possible to reduce the time required for charging while maintaining the full charge capacity at the same level.

Accordingly to the charger of the present invention, when the residual capacity of the secondary battery is not reduced significantly, a current value is increased immediately, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

In view of the foregoing embodiments, the present invention can be summarized as follows. Specifically, a charging method in accordance with one aspect of the present invention includes: a constant-current charging step wherein a constant charge current is supplied to a secondary battery to be charged to a predetermined end voltage; and a constant-voltage charging step wherein the predetermined end voltage is maintained by reducing the charge current after the secondary battery is charged to the end voltage, wherein the constant-current charging step includes a charging step to be carried out with the end voltage set to an open circuit voltage (OCV) which is a voltage when no current is flowing, and with a voltage across charge terminals of the battery pack set to an overvoltage above the OCV, and the constant-voltage charging step includes a step of reducing the voltage across the charge terminals to the OCV after the voltage across the charge terminals is increased to the overvoltage or after the charge current across the charge terminals is reduced to or below a predetermined current level.

According to the foregoing method of charging the secondary battery such as a lithium ion battery, the constant current (CC) charging wherein a constant charge current is supplied to the secondary battery to be charged to a predetermined end voltage (e.g. 4.2 V in the case of the lithium ion battery) as a target voltage, subsequent to the trickle charging to be carried out in the initial stage of the charging process wherein a small current is applied. Then, after the secondary battery is charged to the end voltage, a constant-voltage charging is performed wherein the predetermined end voltage is maintained by reducing the charge current. In the constant-voltage charging step, the end voltage is set to an open circuit voltage (OCV) which is a voltage when no current is flowing, and in the constant-current charging step, the voltage of a charge terminal of the battery pack is set to an overvoltage above the OCV. After the voltage across the charge terminals is increased to the overvoltage and a transition is made to the constant-voltage charging, or after the charge current of the charge terminal is reduced to or below a predetermined level, the voltage across the charge terminals is reduced to the end voltage.

As described, according to the foregoing charging method of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state without a need of detecting a residual capacity before the charging process is to be performed, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

In the foregoing charging method, the charge current for the constant-current charging step is set in a range of from 0.8 C to 4 C provided that a current value with which a nominal capacity of the secondary battery is discharged in an hour by carrying out constant current discharging, is 1 C.

According to the foregoing structure, as described above, no higher voltage than the end voltage is applied to the secondary battery at the time of the constant-current (CC) charging and overcharge is reliably prevented regardless of the state of the secondary battery. Thus, the charge current value can be set in a range of 0.8 C to 4 C which is higher as compared with the conventional value of 0.7 C, provided that a current value with which a nominal capacity NC is discharged in an hour by carrying out constant current discharging is 1 C.

According to the foregoing structure, in addition to the feature that the voltage across the charge terminals is set higher than the end voltage at the time of the constant-current (CC) charging, the charge current is increased. It is therefore possible to inject a still larger amount of charges, thereby reducing an overall charging time.

The foregoing charging method further includes: a trickle charging step to be carried out in an initial stage of a charging process of the secondary battery, wherein the trickle charging step includes the steps of: setting a switch voltage to a voltage below the end voltage for the trickle charging step and carrying out a trickle charging with a trickle charge current from a beginning of the charging process, charging with a current which is larger than the trickle charge current after the voltage across the charge terminals is increased to the switch voltage, and terminating the trickle charging step when the voltage across the charge terminals is increased to the end voltage for the trickle charging step.

According to the foregoing method of the trickle charging to be performed in the initial stage of the charging process of the secondary battery such as a lithium ion battery, or the like, the conventional trickle charging period (area) is divided into a first half and a second half without changing the end voltage from that adopted in the conventional trickle charging method. In the first half, the trickle charging is performed in the same manner as the conventional trickle charging method. In the second half, the trickle charging is performed with a trickle charge current larger than that adopted in the conventional method. With this structure, the switch voltage is set to a voltage below the end voltage for the conventional trickle charging. When the charging operation is started, the foregoing first half where the conventional trickle charging is performed starts and ends when the cell voltage of the secondary battery reaches the switch voltage. When the cell voltage reaches the switch voltage, a transition is made to the second half where the trickle charging is performed with a trickle charge current larger than that of the conventional trickle charging method. Then, when the cell voltage reaches the end voltage for the conventional trickle charging, the trickle charging is terminated. According to the foregoing method, the first half where the trickle charging is carried out in the conventional manner is performed in a shorter period of time, and is transited to the second half of the trickle charge period (area) where the trickle charging is performed with a larger trickle charge current.

The switch voltage is set to the lowest limit voltage provided that a damage on the secondary battery can be avoided, in connection with the current value of the current larger than the conventional trickle charge current, and the current value is set to the largest limit value. After terminating the trickle charging, a normal charge control such as constant current/constant-voltage charging is performed.

Accordingly, when the residual capacity of the secondary battery is not reduced significantly, a transition is made immediately to the second half, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

According to the foregoing structure, it is possible to reduce the charging time at the time of the trickle charging as described above, while reducing the charging time at the time of the constant current/constant-voltage charging, thereby reducing an overall time required for charging.

A battery pack according to the present invention includes: a secondary battery; a current detector which detects a charge current of the secondary battery; a communicator which communicates with a charger; and a charge controller which carries out a constant-current charging wherein a constant charge current is supplied to the secondary battery to be charged to a predetermined end voltage by sending a request for a charge voltage and a charge current to the charger via the communicator and which carries out a constant-voltage charging wherein the end voltage is maintained by reducing the charge current after the secondary battery is charged to the end voltage, wherein the charge controller sets the end voltage to an OCV, which is a voltage when no current is flowing, requests the charger via the communicator for a charge voltage with which the voltage across the charge terminals can be increased to an overvoltage above the OCV when carrying out the constant-current charging, and requests for a charge voltage with which the voltage across the charge terminals can be maintained at the OCV after the voltage across the charge terminals reaches the overvoltage and the current detector detects that the charge current is reduced to or below a predetermined current level.

According to the foregoing structure of the battery pack which includes the secondary battery such as a lithium ion battery, and the current detector, the communicator and the charge controller for charging the secondary battery, the charge controller sends a request for a charge voltage and a charge current to the charger via the communicator, to carry out the constant-current (CC) charging wherein a constant charge current is supplied to the secondary battery to be charged to a predetermined end voltage (e.g. 4.2 V in the case of the lithium ion battery) as a target voltage. Then, after the secondary battery is charged to the end voltage, a constant-voltage charging is performed. When the constant-voltage charging is to be performed, the charge controller sets the end voltage to an open circuit voltage (OCV) which is a voltage when no current is flowing, requests the charger via the communicator for such charge voltage with which the voltage across the charge terminals of the battery pack is increased an overvoltage above the end voltage. Then, when the voltage across the charge terminals reaches the overvoltage, and the current detector detects that the charge current across the terminals is reduced to or below a predetermined current level, the charge controller requests the charger for a charge voltage with which the voltage across the charge terminals can be reduced to the end voltage step by step or gradually, and for a charge current with which the voltage as reduced can be maintained.

As described, according to the foregoing charging method of the present invention, although a voltage above the end voltage is applied across the charge terminals, such voltage is not applied to the respective cells in the constant-current (CC) charging. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state without a need of detecting a residual capacity before the charging process is to be performed, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

In the foregoing battery pack, the charge current for the constant-current charging step is set in a range of from 0.8 C to 4 C provided that a current value with which a nominal capacity of the secondary battery is discharged in an hour by carrying out constant current discharging, is 1 C.

According to the foregoing structure, a voltage above the end voltage is not applied to the secondary battery in the constant-current (CC) charging, and overcharge is reliably prevented regardless of the state of the secondary battery. It is therefore possible to set the charge current value in a range of 0.8 C to 4 C, which is higher than the charge current value (0.7 C) adopted in the conventional structure.

According to the foregoing structure, in addition to the feature that the voltage across the charge terminals is set higher than the end voltage at the time of the constant-current (CC) charging, the charge current is increased. It is therefore possible to inject a still larger amount of charges, thereby reducing an overall charging time.

The above battery pack further includes a voltage detector which detects a cell voltage of the secondary battery; and a trickle charge circuit capable of varying a charge current to be supplied to the secondary battery and trickle-charging the secondary battery while limiting the charge current from the charger in a period from a begging of the charging process until the voltage detector detects that the cell voltage of the secondary battery reaches a predetermined end voltage for the trickle charging, wherein the charge controller controls the trickle charge circuit to increase the charge current when the voltage detector detects that the cell voltage reaches a predetermined switch voltage set below the end voltage for the trickle charging, and to terminate the trickle charging when the cell voltage reaches the end voltage for the trickle charging.

According to the foregoing structure of the battery pack which includes the secondary battery such as a lithium ion battery, and the elements for charging the secondary battery, i.e., the trickle charge circuit, the voltage detector, the communicator and the charge controller, wherein when carrying out the trickle charging, a constant trickle charge current is supplied from the charger, while a variable charge current can be supplied to the secondary battery from the trickle charge circuit, constituted, for example, by a parallel circuit made up of current limiting resistors for limiting current flowing in the circuit and a switching element which permits the current to flow without limiting. The charge control circuit then increases the charge current to be supplied to the trickle charge circuit when the voltage detection circuit detects that the cell voltage reaches the predetermined switch voltage set lower than the end voltage for the trickle charging, and terminates the trickle charging when the cell voltage reaches the end voltage for the trickle charging. According to the foregoing method, the conventional trickle charging area is divided into the first half where the trickle charging is carried out in the conventional manner and the second half where the trickle charging is performed with a larger trickle charge current without changing the end voltage for the trickle charging, and the first half where the trickle charging is carried out in the conventional manner is performed in a shorter period of time, and is transited to the second half of the trickle charge period (area) where the trickle charging is performed with a larger trickle charge current.

Accordingly, if the residual capacity of the secondary battery is not reduced significantly, a transition is made immediately to the second half, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

In the above battery pack, the trickle charge circuit includes two current limiting resistors and FETs paired with the two current limiting resistors, and the charge controller switches a resistance value of the trickle charge circuit by controlling ON/OFF of the FETs, thereby varying the charge current to be supplied to the secondary battery.

According to the foregoing structure, the trickle charge circuit includes the two current limiting resistors and the FETS paired with the current limiting resistors in order to be able to supply a current larger than the conventional trickle charge current as the trickle charge current. The current limiting resistors and the FETs may be constructed into an arbitrary series-parallel circuit. For example, series circuits of current limiting resistors having different resistance values and FETs paired with the current limiting resistors are connected in parallel with each other, and the charge controller can increase the trickle charge current through a selective control of turning on the FET corresponding to the current limiting resistor having the higher resistance value at the start of charging and turning on the FET corresponding to the lower current limiting resistor having the lower resistance value when the switch voltage is reached. Alternatively, series circuits of current limiting resistors having different or equal resistance values and FETs paired with the current limiting resistors are connected in parallel with each other, and the charge controller can increase the trickle charge current by turning on only the FET corresponding to one current limiting resistor to set the higher resistance value at the start of charging and turning on the FETs corresponding to the both current limiting resistors to set the lower resistance value when the switch voltage is reached. Further, two current limiting resistors and one FET are connected in series, another FET is provided for bypassing one current limiting resistor, and the charge controller can increase the trickle charge current by turning only the FET in series on to set the higher resistance value at the start of charging and turning the FET for bypass on to set the lower resistance value when the switch voltage is reached.

The foregoing structure provides one example of the trickle charging circuit.

In the foregoing battery pack, the charge controller requests the charger via the communicator for a charge current which is larger than a charge current for the trickle charging and is smaller than a constant charge current for the constant-current charging, and directly outputs the charge current to the trickle charge circuit when the voltage detector detects that the cell voltage reaches the predetermined switch voltage set below the end voltage for the trickle charging, and makes a transition from the trickle charging to the constant-current charging and requests the charger for a constant charge current when the voltage detector detects that the cell voltage reaches the end voltage for the trickle-charging.

According to the foregoing structure of the battery pack which includes the secondary battery such as a lithium ion battery, and the elements for charging the secondary battery, i.e., the trickle charge circuit, the voltage detector, the communicator and the charge controller, wherein the charge controller controls the trickle charge circuit to carry out the trickle charging for charging the secondary battery while limiting the charge current from the charger in the period from the beginning of the charging period until the voltage detector detects that the cell voltages of the secondary battery reach the predetermined end voltage for the trickle charging. When the cell voltage reaches the end voltage for the trickle charging, the charge controller controls the trickle charge circuit to directly output the charge current from the charger to the trickle charge circuit, and sends a request the charger via the communicator for a charge voltage and a charge current, thereby carrying out the constant-current constant-voltage charging with respect to the secondary battery. In the battery pack of the foregoing structure, currents of two different values are requested to the charger for the trickle charging, i.e. i) the current of the same value as the conventional current value and ii) the current of a larger value than the conventional current value and of a smaller value than the constant current value for the constant current/constant-voltage charging. The charge controller requests the charger for a charge current via the communicator which is larger than a current in the trickle charging and is smaller than a constant current in the constant-current charging, and directly outputs the charge current to the trickle charge circuit when the voltage detector detects that the cell voltage is increased to the predetermined switch voltage set below the end voltage for the trickle charging. The charger controller than makes a transition from the trickle charging to the constant-current charging and requests the charger for a constant charge current when the voltage detector detects that the cell voltage reaches the end voltage for the trickle-charging. According to the foregoing method, the conventional trickle charging area is divided into the first half where the trickle charging is carried out in the conventional manner and the second half where the trickle charging is performed with a larger trickle charge current without changing the end voltage for the trickle charging, and the first half where the trickle charging is carried out in the conventional manner is performed in a shorter period of time, and is transited to the second half of the trickle charge period (area) where the trickle charging is performed with a larger trickle charge current.

Accordingly, if the residual capacity of the secondary battery is not reduced significantly, a transition is made immediately to the second half, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

According to the foregoing structure, it is possible to reduce the charging time at the time of the trickle charging as described above, while reducing the charging time at the time of the constant current/constant-voltage charging, thereby reducing an overall time required for charging.

A charger of the present invention includes: a charge current supply circuit which supplies a charge current to a battery pack; a communicator which communicates with the battery pack; and a charge controller which carries out a constant-current charging wherein a constant charge current is supplied to a secondary battery of the battery pack to be charged to a predetermined end voltage by controlling a charge current from the charge current supply circuit in response to a request from the battery pack inputted via the communicator and which carries out a constant-voltage charging by reducing the charge current so as to maintain the end voltage after the second battery is charged to the end voltage, wherein when the constant-current charging is to be carried out, the charge controller sets the end voltage to an OCV, which is a voltage when no current is flowing, in response to a request from the battery pack inputted via the communicator, and controls the charge current supply circuit so as to output such charge current that the voltage across the charge terminals of the battery pack becomes higher than the OCV, and when the voltage across the charge terminals reaches the overvoltage, and a transition is made from the constant-current charging to the constant-voltage charging, or when the charge current across the charge terminals is reduced to or below a predetermined current level, the charge controller controls the charge current supply circuit so as to reduce the voltage across the charge terminals to the OCV and to supply such a charge current to maintain the voltage across the charge terminals at the OCV.

The charger of the foregoing structure includes the charge current supply circuit, the communicator and the charge controller, and charges a secondary battery such as a lithium ion battery in the battery pack by carrying out the constant current (CC) charging with a constant charge current to charge the secondary battery to the predetermined end voltage, and carrying out the constant-voltage (CV) charging for maintaining the end voltage by reducing the charge current when the secondary battery reaches the end voltage. The foregoing charger is arranged on the side of the battery pack such that the end voltage is set to the OCV, and a request is made for such charge voltage that the voltage across the charge terminals of the battery pack becomes an overvoltage above the end voltage. The foregoing charger is further arranged such that upon receiving by the communicator, a request made for such charge voltage for reducing the voltage across the charge terminals to the end voltage when a transition is made to the constant voltage (CV) charging, or the charge current is reduced to or below the predetermined current level, and a request made for such charge current for maintaining the voltage as reduced, the charge control section controls the charge current supply circuit to output the charge voltage and the charge current as requested.

With the foregoing structure, although a voltage above the end voltage is applied across the charge terminals, such voltage is not applied to the respective cells in the constant-current (CC) charging period. Moreover, a difference in voltage between the voltage across the terminals and the cell voltage can be consumed by a voltage drop caused by switches and current detection resistances provided for safety control and the charge/discharge control. With this arrangement, since the charge current in the constant current (CC) charging period can be reduced in a short period of time, a transition can be made immediately to the constant-voltage (CV) charging period even for almost fully charged battery packs. The foregoing charging method of the present embodiment is therefore applicable to battery packs in any state without a need of detecting a residual capacity before the charging process is to be performed, and the charge voltage to be applied in the constant-voltage (CV) charging period can be increased, which in turn increases an amount of charges to be injected while surely preventing an application of an overvoltage to the respective cells, and thereby preventing an overcharge of the respective cells. Additionally, by setting a charge voltage and a reduction in current to be detected to the same level as those of the conventional method, as a final full charge condition, the time required for an overall charging process can be reduced, while maintaining the full charge capacity at the same level.

In the foregoing charger, the charge controller sets the charge current value for the constant-current charging in a range of from 0.8 C to 4 C provided that a current value with which a nominal capacity of the secondary battery is discharged in an hour by carrying out constant current discharging, is 1 C.

As described, according to the foregoing structure, a voltage above the end voltage is not applied to the secondary battery in the constant-current (CC) charging, and overcharge is reliably prevented regardless of the state of the secondary battery. It is therefore possible to set the charge current value in a range of 0.8 C to 4 C, which is higher than the charge current value (0.7 C) adopted in the conventional structure.

According to the foregoing structure, in addition to the feature that the voltage across the charge terminals is set higher than the end voltage at the time of the constant-current (CC) charging, the charge current is increased. It is therefore possible to inject a still larger amount of charges, thereby reducing an overall charging time.

The charger of the foregoing structure may be further arranged such that in response to an instruction for switching the trickle charge current as received by the communicator in the trickle charging process, the charge controller controls the charge current supply circuit to directly output the charge current to the battery pack, and to supply a charge current set larger than the trickle charge current and is smaller than the constant current for the constant-current charging.

The foregoing structure of the charger includes the charge current supply circuit, the communicator and the charge controller, and charges the secondary battery such as a lithium ion battery in the battery pack by carrying out the constant current/constant-voltage charging subsequent to the trickle charging. The foregoing charger is arranged on the side of the battery pack such that a switch voltage is set to a voltage below the end voltage for the trickle charging, and when the cell voltage reaches the switch voltage, a request for switching the charge current is made to the charger, and in response to the request, the charge control circuit outputs the charge current from the charge current supply circuit directly to the battery pack, and supplies to the charge current supply circuit, a charge current of a larger value than the conventional trickle charge current and of a smaller value than the constant current value for the constant-current/constant-voltage charging.

Accordingly, when the residual capacity of the secondary battery is not reduced significantly, a transition is made immediately to the second half, and if the cell voltages of the secondary battery are lower than the switch voltage and the residual capacity is almost null, the charging is performed at low speed with the conventional trickle charge current to increase the cell voltages. When the cell voltages are increased to the predetermined level, the charging is performed with a current larger than the conventional trickle charge current. As a result, the time required for the trickle charging can be reduced, thereby reducing a time required for an overall charging process.

### INDUSTRIAL APPLICABILITY

The present invention is applicable to battery packs in any state, and permits an increase in amount of charges to be injected while surely preventing an application of an overvoltage to cells of a secondary battery, or overcharging the cells, and realizes a reduction in overall time required for charging. Therefore, the present invention can be suitably applied to a battery pack and a charger of the same capable of performing constant current/constant-voltage charging subsequent to a trickle charging.

1-11. (canceled)

12. A charging method, comprising:
a constant-current charging step wherein a constant charge current is supplied to a secondary battery to be charged to a predetermined end voltage; and
a constant-voltage charging step wherein the predetermined end voltage is maintained by reducing the charge current after said secondary battery is charged to the end voltage, wherein:
said constant-current charging step includes a charging step to be carried out with the end voltage set to an open circuit voltage (OCV) which is a voltage when no current is flowing, and with a voltage across charge terminals of said battery pack set to an overvoltage above the OCV, and
said constant-voltage charging step includes a step of reducing the voltage across the charge terminals to the OCV after the voltage across the charge terminals is increased to the overvoltage or after the charge current across the charge terminals is reduced to or below a predetermined current level.

13. A charging method according to claim 12, wherein the charge current for said constant-current charging step is set in a range of from 0.8 C to 4 C provided that a current value with which a nominal capacity of said secondary battery is discharged in an hour by carrying out constant current discharging, is 1 C.

14. A charging method according to claim 12, further comprising:
a trickle charging step to be carried out in an initial stage of a charging process of said secondary battery,
wherein said trickle charging step includes the steps of:
setting a switch voltage to a voltage below the end voltage for said trickle charging step and carrying out a trickle charging with a trickle charge current from a beginning of the charging process,
charging with a current which is larger than the trickle charge current after the voltage across the charge terminals is increased to said switch voltage, and
terminating the trickle charging step when the voltage across the charge terminals is increased to the end voltage for said trickle charging step.

15. A battery pack, comprising:
a secondary battery;
a current detector which detects a charge current of said secondary battery;
a communicator which communicates with a charger; and
a charge controller which carries out a constant-current charging wherein a constant charge current is supplied to said secondary battery to be charged to a predetermined end voltage by sending a request for a charge voltage and a charge current to the charger via said communicator and which carries out a constant-voltage charging wherein the end voltage is maintained by reducing the charge current after said secondary battery is charged to the end voltage,
wherein said charge controller sets the end voltage to an OCV, which is a voltage when no current is flowing, and requests said charger via said communicator, i) for a charge voltage with which the voltage across the charge terminals can be increased to an overvoltage above the OCV when carrying out said constant-current charging, and ii) for a charge voltage with which the voltage across the charge terminals can be maintained at the OCV after the voltage across the charge terminals reaches the overvoltage and the current detector detects that the charge current is reduced to or below a predetermined current level.

16. A battery pack according to claim 15, wherein the charge current for said constant-current charging step is set in a range of from 0.8 C to 4 C provided that a current value with which a nominal capacity of said secondary battery is discharged in an hour by carrying out constant current discharging, is 1 C.

17. A battery pack according to claim 15, further comprising:
a voltage detector which detects a cell voltage of said secondary battery; and
a trickle charge circuit capable of varying a charge current to be supplied to said secondary battery and trickle-charging said secondary battery while limiting the charge current from the charger in a period from a begging of the charging process until said voltage detector detects that the cell voltage of said secondary battery reaches a predetermined end voltage for the trickle charging,
wherein the charge controller controls said trickle charge circuit to increase the charge current when said voltage detector detects that the cell voltage reaches a predetermined switch voltage set below the end voltage for the trickle charging, and to terminate the trickle charging when the cell voltage reaches the end voltage for said trickle charging.

18. A battery pack according to claim 15, wherein:
said trickle charge circuit includes two current limiting resistors and FETs paired with said two current limiting resistors, and
said charge controller switches a resistance value of said trickle charge circuit by controlling ON/OFF of the FETs, thereby varying the charge current to be supplied to said secondary battery.

19. A battery pack according to claim 15, wherein:
said charge controller i) requests said charger via said communicator for a charge current which is larger than a charge current for said trickle charging and is smaller than a charge constant current for said constant-current charging, and directly outputs the charge current to said trickle charge circuit when said voltage detector detects that the cell voltage reaches the predetermined switch voltage set below the end voltage for the trickle charging, and ii) makes a transition from the trickle charging to the constant-current charging and requests said charger for a constant charge current when said voltage detector detects that the cell voltage reaches the end voltage for the trickle-charging.

20. A charger, comprising:
a charge current supply circuit which supplies a charge current to a battery pack;
a communicator which communicates with said battery pack; and
a charge controller which carries out a constant-current charging wherein a constant charge current is supplied to a secondary battery of the battery pack to be charged to a predetermined end voltage by controlling a charge current from said charge current supply circuit in response to a request from said battery pack inputted via said communicator and which carries out a constant-voltage charging by reducing the charge current so as to maintain the end voltage after said second battery is charged to the end voltage,
wherein when the constant-current charging is to be carried out, said charge controller sets the end voltage to an OCV, which is a voltage when no current is flowing, in response to a request from said battery pack inputted via said communicator, and controls said charge current supply circuit so as to output such charge current that the voltage across the charge terminals of said battery pack becomes higher than the OCV, and
when the voltage across the charge terminals reaches the overvoltage, and a transition is made from the constant-current charging to the constant-voltage charging, or when the charge current across the charge terminals is reduced to or below a predetermined current level, said charge controller controls said charge current supply circuit so as to reduce the voltage across the charge terminals to the OCV and to supply such a charge current to maintain the voltage across the charge terminals at the OCV.

21. A charger according to claim 20, wherein:
said charge controller sets the charge current value for said constant-current charging in a range of from 0.8 C to 4 C provided that a current value with which a nominal capacity of said secondary battery is discharged in an hour by carrying out constant current discharging, is 1 C.

22. A charger according to claim 20, wherein in response to an instruction for switching the trickle charge current as received by the communicator in a trickle charging process, said charge controller controls the charge current supply circuit to directly output the charge current to said battery pack, and to supply a charge current set larger than the trickle charge current and is smaller than the constant current for said constant-current charging.
